(19) United States
(12) Patent Application Publication
(10) Pub. No.: US 2006/0043315 A1
(43) Pub. Date: Mar. 2, 2006

(54) Very large-scale integration (VLSI) circuit for measuring charge pulses

(76) Inventors: Walter Cook, Long Beach, CA (US); Jill Bumham, Pasadena, CA (US)

Correspondence Address: Tope-McKay and Associates, 23852 Pacific Coast Highway, # 311, Malibu, CA, 90265, US

(21) Appl. No.: 11/207,504

(22) Filed: Aug. 19, 2005

Related U.S. Application Data
(60) Provisional application No. 60/602,986, filed on Aug. 19, 2004.

(51) Int. Cl. B01D 59/44

(52) U.S. Cl. 250/489

(57) ABSTRACT

The present invention relates to a detector system. More specifically, the present invention relates to a detector system that comprises an ionizing radiation detector; a very large-scale integration (VLSI) circuit bonded with the ionizing radiation detector for receiving a signal from the ionizing radiation detector; and a microprocessor connected with the VSLI circuit for operating the VLSI circuit. Signals are received by the ionizing radiation detector, passed through the VLSI circuit, and processed by the microprocessor. The VLSI circuit includes a plurality of readout channels. Each readout channel includes a pre-amplifier; a plurality of sampling capacitors; a shaping amplifier; a discriminator; and a latch.

### PRIORITY CLAIM

The present application is a Continuation-in-Part application, claiming the benefit of priority of U.S. Provisional Patent Application No. 60/602,986, filed on Aug. 19, 2004, entitled, “Ultra Low-Power 64 Channel Detector Readout Chip (“Handheld Chip”)” and also claiming the benefit of priority to U.S. patent application Ser. No. 10/923,249, filed Aug. 20, 2004, entitled “Cadmium-Zinc-Telluride Detectors.”

### BACKGROUND OF THE INVENTION

(1) Technical Field

The present invention relates to a detector readout chip. More specifically, the present invention relates a very large-scale integration (VLSI) circuit that is operable for measuring the amplitude of charges pulses from a detector such as a CdZnTe pixel detector.

(2) Background

Certain detectors, such as Cadmium Zinc Telluride (CZT) detectors, are used to detect ionizing radiation. Ionizing radiation detectors can be used by emergency and other relevant personnel to detect the presence of dangerous radiation. In other applications, radiation detectors can be used by security forces to scan for and detect nuclear and other radioactive devices.

When detecting ionizing radiation, the detectors form a charge pulse, while an attached circuit measures the amplitude of the charge pulses. Existing circuits are typically bulky and consume large amounts of power, making them undesirable for use in a hand held unit.

Thus, a continuing need exists for a circuit that minimizes power consumption and is designed for use in a mobile battery powered application.

### SUMMARY OF THE INVENTION

The present invention relates to a very large scale integration circuit for measuring charge pulses in a detector system. The detector system comprises an ionizing radiation detector; a very large-scale integration (VLSI) circuit bonded with the ionizing radiation detector for receiving a signal from the ionizing radiation detector; and a microprocessor connected with the VSLI circuit for operating the VLSI circuit, wherein signals are received by the ionizing radiation detector, passed through the VLSI circuit, and processed by the microprocessor.

In another aspect, the ionizing radiation detector is a Cadmium Zinc Telluride (CZT) detector.

In another aspect, the ionizing radiation detector comprises a single CZT crystal having a first side and a second side; a anode plane connected with the first side of the CZT crystal, wherein the anode plane comprises: a plurality of pixels; a guard ring surrounding the plurality of pixels; and a cathode connected with the second side of the CZT crystal.

In yet another aspect, the VLSI circuit comprises a plurality of readout channels, with each readout channel connected with one of the plurality of pixels. Each readout channel includes a pre-amplifier; a plurality of sampling capacitors; a shaping amplifier; a discriminator; and a latch.

Additionally, each pre-amplifier is direct current (DC) coupled to the detector.

In yet another aspect, the plurality of readout channels includes 64 identical readout channels.

Furthermore, the plurality of sampling capacitors includes 16 sampling capacitors.

In another aspect, the VLSI circuit is formed to support pulse height analysis of X-ray and gamma-ray photons of energies from 20 keV to several MeV.

In another aspect, the present invention comprises a circuit for measuring charge pulses from a detector. The circuit comprises a plurality of readout channels, with each readout channel including a pre-amplifier; a plurality of sampling capacitors; a shaping amplifier; a discriminator; and a latch.

The present invention also comprises a method for forming the circuit and detector described herein. The method comprises acts of forming the respective parts to operate as described.

Finally, the present invention also comprises a method for measuring a charge pulse, the method comprising acts of performing the operations described herein.

### BRIEF DESCRIPTION OF THE DRAWINGS

The objects, features and advantages of the present invention will be apparent from the following detailed descriptions of the preferred aspect of the invention in conjunction with reference to the following drawings.

FIG. 1 is a schematic of a circuit according to the present invention;

FIG. 2 is a schematic of a direct current (DC) feedback circuit according to the present invention;

FIG. 3 is an illustration of a single channel according to the present invention;

FIG. 4 is an illustration of a complete chip according to the present invention;

FIG. 5 depicts a block diagram of one embodiment of a detector system in accordance with the present invention; and

FIG. 6 is a table illustrating exemplary results of the circuit in operation.

### DETAILED DESCRIPTION

The present invention relates to a detector readout chip. More specifically, the present invention relates a very large-scale integration (VLSI) circuit that is operable for measuring the amplitude of charges pulses from a detector such as a CdZnTe pixel detector. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles, defined herein, may be applied to a wide range of embodiments. Thus, the present invention is not intended to be limited to the embodiments presented, but is to be accorded the widest scope consistent with the principles and novel features disclosed herein. Furthermore, it should be noted that unless explicitly stated otherwise, the figures included herein are illustrated diagrammatically and without any specific scale, as they are provided as qualitative illustrations of the concept of the present invention.

(1) Introduction

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

The description outlined below sets forth a detector readout chip. More specifically, the description sets forth a very large-scale integration (VLSI) circuit that is operable for measuring the amplitude of charges pulses from a detector such as a CdZnTe pixel detector. The description also includes several embodiments of a detector system comprising the VLSI circuit.

(2) Circuit Details

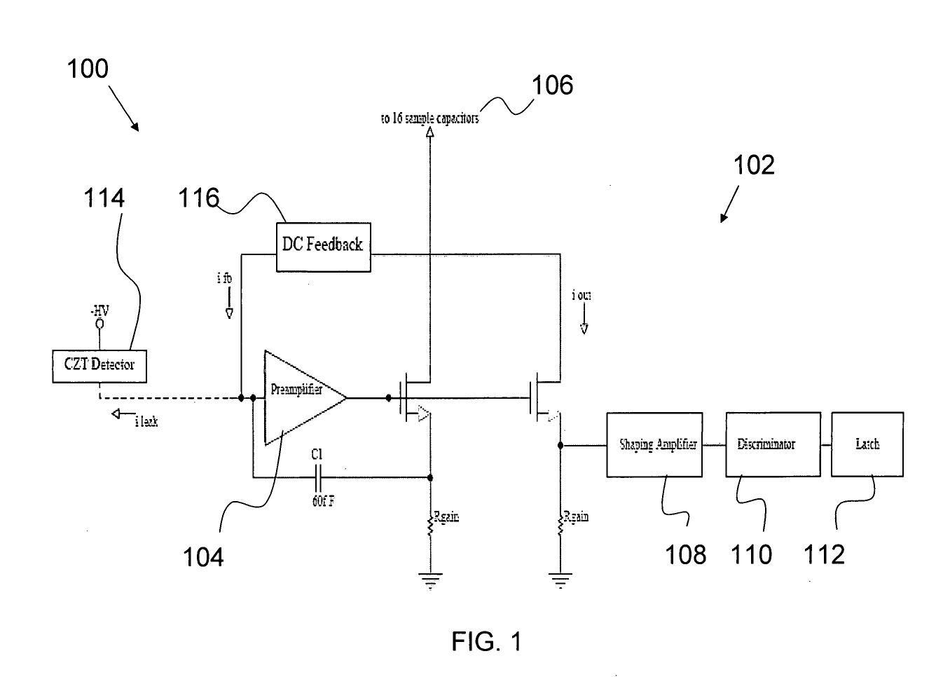

The present invention relates to a very large-scale integration (VLSI) circuit. As shown in FIG. 1, the VLSI circuit (or “chip”) 100 contains a plurality of readout channels 102 (a non-limiting example of which includes 64 identical readout channels), each including a low-noise preamplifier 104, a plurality of sampling capacitors 106 (a non-limiting example of which includes 16 capacitors), a shaping amplifier 108, a discriminator 110, and a latch 112. The circuit 100 is intended for use in measuring the amplitude of charge pulses from detectors such as Cadmium Zinc Telluride (CZT) detectors 114. The design incorporates a method of charge pulse amplitude measurement that minimizes power consumption while maintaining excellent low-noise performance.

The new VLSI circuit 100 was designed for use in a mobile battery powered application, where the ultra-low power consumption of the chip is an essential feature.

Unique to the circuit 100 is a novel method of direct current (DC) feedback 116 for the preamplifiers 104. The DC feedback 116 method allows the preamplifiers 104 to be DC coupled to the detector 114, yet maintains linear preamplifier operation over a very large detector leakage current range. As a non-limiting example, the detector leakage current range is from pico-Amps up to 15 nano-Amps. The DC coupling of detector 114 and preamplifiers 104 is very important in compact applications, eliminating the need for bulky coupling capacitors. The wide range of leakage current handling capacity is also important for applications in which the detector may see high temperatures.

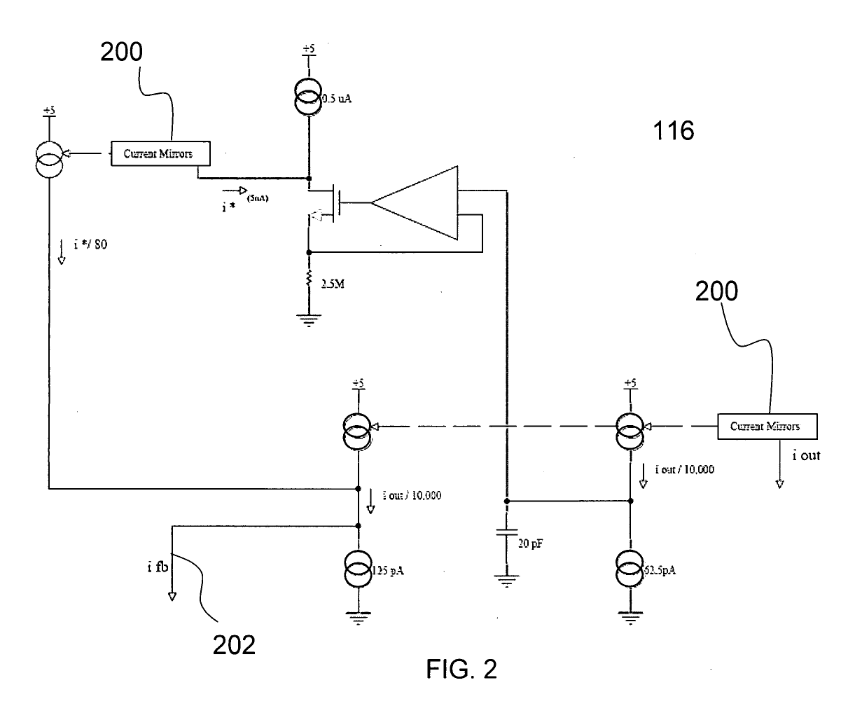

Illustrated in FIG. 2, the new DC feedback 116 method requires no external parts, all components being fabricated directly as part of the chip design. The preamplifier has 2 feedback paths for the current. The first path is a simulated feedback resistor. On-chip resistors are limited in value due to their large physical size when implemented with polysilicon. In this design, current mirrors 200 are used to divide the preamplifier output current down, such as down by a factor of 10,000. This divided current is fed back to the input, which produces the effect of a large feedback resistor (as much as 2.5 Gohm) and uses much less chip area. The second feedback path provides automatic balancing of the leakage current while maintaining proper DC biasing for amplifier operation. The detector leakage current is compensated for by the feedback current (ifb) 202.

The chip design allows several chips to be ganged together efficiently, and provides flexibility in the choice of dynamic range. The chip supports pulse height analysis of X-ray and gamma-ray photons of energies from 20 kilo-electron volts (keV) to several mega-electron volts (MeV) with typical electronic noise contribution to resolution of 1.5 to 3 keV FWHM depending on detector leakage current. Typical power consumption is only 30 microwatts (uW) per channel.

While certain aspects of the low-power architecture of the new chip are derived from the earlier high-energy focusing telescope (HEFT) chip (i.e., U.S. patent application Ser. No. 10/923,249), there are several differences listed below, that facilitate the intended cost- and power-sensitive applications. U.S. patent application Ser. No. 10/923,249 (“Application '249) is incorporated herein as though fully set forth herein.

The HEFT chip described in Application '249 was designed for bump bonding to a detector, while the chip of the present invention is designed for connection through an intermediate printed circuit board using standard wire bonding technology. (The approach for the HEFT chip provides better performance, but requires a perfect geometrical match between detector and chip, and is expensive.)

The chip (i.e., circuit) of the present invention is intended to readout larger “pixels” (˜2 mm) than the HEFT chip (˜0.5 mm) so that fewer chips/channels are needed for a given area of detector. Additionally, the circuit is also capable of DC coupling (like the HEFT chip) but is able to accommodate much higher detector leakage currents (i.e., 15 nano-amperes (nA) versus 100 pico-amperes (pA)). Further, the dynamic range of the present invention (i.e., 20 keV to several MeV) is much broader and shifted to higher energy relative to the HEFT chip (i.e., 5 keV to 150 keV).

The layout of the present invention is quite different from that of the HEFT chip due to the reduced number of channels (e.g., 64 versus 1152). The chip's layout is based on a linear array of channels versus the rectangular array of HEFT. The linear arrangement provides for sensitive preamplifier inputs to be aligned along one side of the chip, while digital control signals and power enter the opposite side of the chip. The details of the chip layout are quite important to achieving successful low-noise operation.

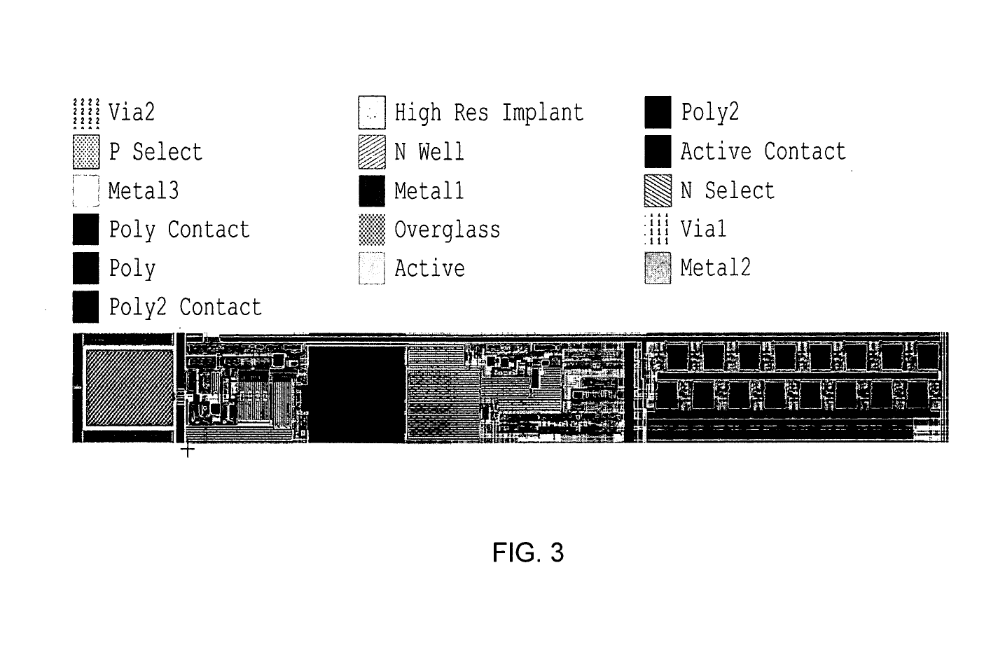

FIG. 3 illustrates the layout of a single channel. As shown in FIG. 3, the channel input pad is on the left side. The channel input pad is constructed of 2 layers of metal and is isolated from neighboring channels with large substrate contacts. Substrate and well contacts are placed methodically throughout the design to provide a solid potential for the transistor back gates. This helps to create a radiation (latch-up) tolerant design. Directly to the right of the input pad is the preamplifier, followed by larger discrete components. Continuing to the right are the discriminator and latch. On the far left there are the 16 sampling capacitors. Great care was taken to isolate the analog and digital components of the design. Sensitive signals were routed in channels that prevent cross talk with other signals. The digital control signals were routed in differential pairs to keep switching noise from coupling into the device. As can be appreciated by one skilled in the art, the relative positions described herein are not meant to be limiting but are for illustrative purposes only, as the components can be placed in various relative configurations to achieve the same result.

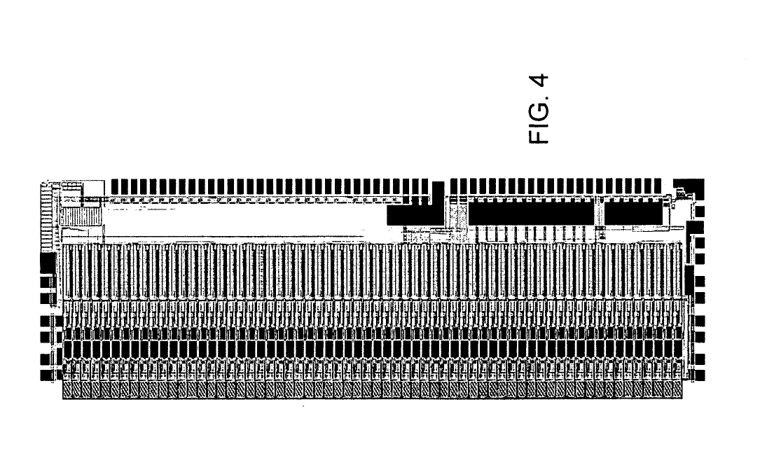

The overall chip layout, shown in FIG. 4, also follows the single channel layout approach. The digital signals pads are located on the upper right hand side of the chip. The bias voltages for the amplifiers are located on the lower right side. All peripheral digital electronics are located as far as possible from the channels. The readout amplifier is isolated in the lower right hand corner of the chip. The power is supplied symmetrically from the top to bottom with wide top layer metal busses.

The chip has an improved diagnostic feature in that both preamplifier and shaping amplifier outputs can be routed off-chip through a special buffer for viewing on an oscilloscope.

As described above, the chip has a readout amplifier that can be normally powered off and tri-stated for ganging without the need for an analog multiplexor. Also as mention earlier, the chip employs a novel DC feedback method. In contrast to the HEFT chip, which used a more complex switched preamplifier reset, the DC feedback for the new chip is continuous and automatic.

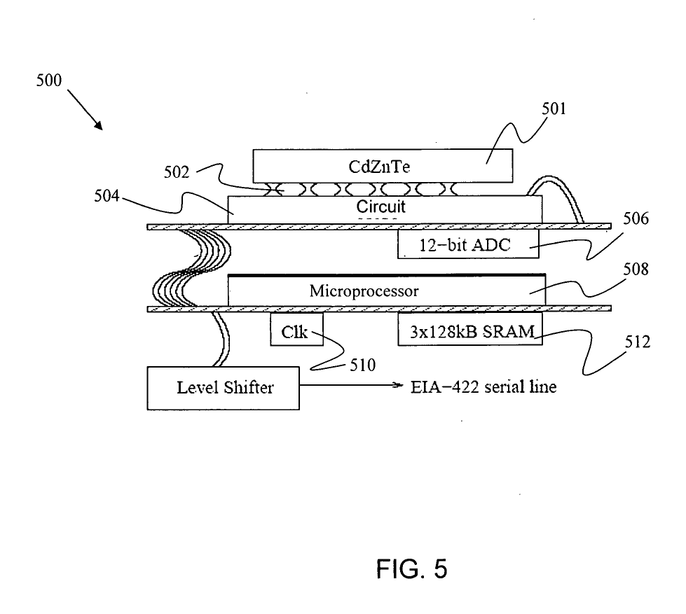

FIG. 5 depicts a block diagram of one embodiment of a detector system 500. The detector system 500 comprises a detector (e.g., CdZnTe crystals 501) with a bond 502 to a very large-scale integration (VLSI) circuit 504. The detector system 500 also comprises an analog-to-digital converter (ADC) 506 connected to the circuit 504 output, and a microprocessor 508 for operating the circuit 504. One skilled in the art will appreciate that a microprocessor 508 may require support electronics such as a clock 510 and memory 512.

(3) Operation

Following is a non-limiting example of the circuit (i.e., chip) in operation. As can be appreciated by one skilled in the art, the numbers, labels, commands, and relative locations used herein are used for convenience and illustrative purposes and can be changed if needed and/or desired. The output of each preamplifier is presented as a voltage signal to a shaping amplifier that in turn drives a discriminator input. A photon of energy above a predetermined threshold (e.g., >20 keV) will trigger the discriminator, set a latch, and signal off-chip logic to begin an event processing cycle.

The output of each preamplifier also is presented as a current signal to a bank of 16 sampling capacitors. On-chip analog switches route the current signal in turn to each capacitor, dwelling a fixed time (e.g., 100's of nsec) on each.

Each capacitor is reset to a fixed voltage prior to its integration period. The process of acquisition of such current-integrated preamplifier output samples proceeds continuously until an above threshold photon detection occurs. Thus at the time of photon detection the recent time history of the preamplifier output waveform is stored on the bank of 16 capacitors. After photon detection the sampling process is allowed to continue for 8 more samples then is halted. At that point the capacitor bank stores approximately 8 pre-event samples and 8 post-event samples, recording in these samples the preamplifier's step-like response to the photon event. Off-chip logic circuitry now scans the chip to determine which of the 64 channels contain a “hit”, i.e. were triggered by an above threshold detector pulse. For the triggered channels (and optionally near neighbors) the stored charge on each of the 16 capacitors is readout using a specially designed on-chip readout amplifier, together with analog switches that are used to route the stored charges.

The readout sequence is carefully designed to transfer the stored charges, one at a time, to a charge-sensitive readout amplifier. The readout amplifier is reset to a fixed baseline voltage prior to each transfer such that the difference between the final and baseline voltage is accurately proportional to the transferred charge. The charge transfer process returns the voltage on each of the 16 sampling capacitors to their “reset” values. To first order the system transfer function is independent of the sampling capacitance values, such that variations due to manufacturing tolerances do not produce “noise” on the preamplifier output record. This design feature greatly simplifies analysis of the preamplifier output records since it is not necessary to store calibration information separately for each sampling capacitor.

In order to reduce overall system power, the charge-sensitive readout amplifier is normally not powered and its output is in a high impedance condition. This allows the readout amplifiers from several chips to be tied together and input to a single off-chip 12 bit analog-to-digital converter (ADC), eliminating the need for an off-chip analog multiplexor.

Analysis of the preamplifier output record (16 12 bit numbers) is performed off-chip by a micro-processor which extracts a single number proportional to the photon energy. This extraction process performs a similar function as that of the precision pulse shaping and peak detection circuits of a traditional pulse-height analysis system. A key to the system's ultra low power consumption is that these traditional circuit elements are entirely eliminated and their functions replaced by digital signal processing. This allows the meager power resources available to battery-powered applications to be concentrated in the preamplifiers where it is needed to yield the desired low-noise performance.

The chip contains 64 channels of pixel electronics. Each pixel has a test input, a preamplifier, an array of 16 sampling capacitors, a discriminator and control logic. The pixels are supported by a command register, pixel selection electronics, sampling counter/capacitor driver and bias generators. There is a fast trigger output for all pixels and any individual pixel trigger can also be inspected. There is a readout amplifier on-chip that feeds an off chip ADC for measurement data output. There is also scope-out for examining the preamp or shaped signal during operation.

The chip has a 138 bit register that needs to be loaded before operation. Each pixel has two bits stored locally to that pixel pixen and testen. pixen(0-63) allows the trigger from that pixel to contribute to the chip level trigger generated as an OR of enabled pixels on chip. testen(0-63) enables a pixel to accept the control signal tpulse which generates a testpulse for enabled pixels. There are 10 additional scope and gain select bits noted below.

The shift register is loaded by holding the cdatain line high or low while sending a clock pulse to the cmdclkin pin. The cdata is clocked into the register on the negative going edge of cmdclkin. The data can be observed on the cmddataout pin.

| | |
|---|---|
| FIRST IN | testen63 |
| | pixen63 |
| | testen 62 |
| | pixen62 |
| | ... |
| | testen0 |
| | pixen0 |
| | scopen |
| | preout/shapeout (preout =1, shapeout=0) |
| | scopesel1 |
| | scopesel2 (6-bit number to select scope channel) |
| | ... (scopesel6=MSB) |
| | scopesel6 |
| | gainsel0 (selects preamp gain Res value, see table) |
| LAST IN | gainsel1 |

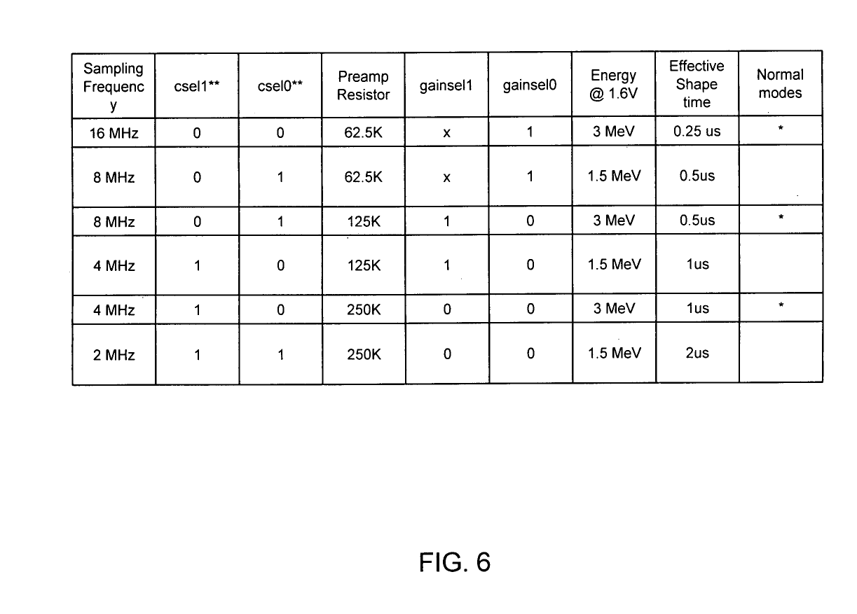

FIG. 6 is a table illustrating exemplary results of the circuit in operation. csel1** and csel0** denote signals used to divide clock oscillator in the Minimal Instruction Set Computer (MISC) using FORTH cmd FREQ!

In operation, there are 4 distinct steps, pre-trigger acquisition, post-trigger acquisition, readout and reset.

Pre-Trigger Acquisition:

Within each pixel, the preamp output signal is integrated in intervals onto an array of 16 sampling capacitors. There is a cyclic 4-bit counter on-chip that select the drivers to reset and charge each capacitor in the array. The drivers and counter must be enabled using chenable, rstenable and ctr-enable. The counters are timed such that each sampling capacitor is reset one clock before it is charged and is charged while the next capacitor in the array is reset. This process ensures there is a valid pre-trigger level stored in the array for each event. There is also a 4-bit cyclic shadow counter in the MISC which is reset with the same ctr-clr signal as the on-chip counters. The value of this counter is used to identify and tag the starting capacitor of the array during the acquisition of an event.

Post-Trigger Acquisition:

Each pixel has a trigger latch which is set when its discriminator fires (disc*). The latch is reset with lreset. The local disc* signal for each pixel is fed to an OR to produce the chip level discriminator signal discout. Once discout is detected by the off-chip logic, lockout is asserted preventing the setting of any other trigger latches. The signal sampling then continues for a selected number of intervals. (MISC controlled interval currently set for 8 intervals with FORTH cmd DT!). ctr-enable and rstenable are disabled one clock before the last capacitor is charged then chenable is disabled. With the current settings there are 8 pre-trigger and 8 post-trigger levels stored in the array.

Readout:

A pixel is selected using the colsel(0-5) inputs. After the chip level discout fires and sampling is stopped, the read signal is asserted. With read asserted, discout becomes the discriminator output for only the selected pixel. Thus, by cycling through the 64 channels and examining discout, the triggered pixels can be found and read. Asserting read also enables rdcolen for the selected pixel. Combinatorial logic within each pixel generates signals local to that pixel. If the pixel is not selected then readen will be low. With read high, capen will be low and shunt will be high. In this case, the sampling capacitor array is disconnected from the readbus. If the pixel is selected for readout by the off-chip logic then readen is high. With read high, capen and shunt are both high. Thus for a selected pixel, each sampling capacitor is able to be connected to the readbus and on-chip readamp by sequencing ctr-enable,chenable and clk. For each reading, rd-reset is asserted which resets the readamp. When a sampling capacitor is connected to the readbus, its charge is transferred to the 0.5 pF feedback capacitor in the readamp. The readamp is essentially an inverting difference amplifier with a gain of 2.

Reset:

After the completion of the readout, a reset is performed. The signal lreset is asserted, clk is turned off, on-chip counters and shadow counter are reset. Then clk is turned on, there is a small delay (3 usec) and ireset is released.

(4) PDHRM Pads:

There are a total of 134 pads. Pin 1 is the upper left hand pin with preamp inputs to the left side. Pads are numbered counter-clockwise.

| #: | Pad name [pad type] function |
|---|---|
| 1: | prein63 [preamp] pixel preamp input |
| . . . | 64 inputs |
| 64: | prein1 [preamp] pixel preamp input |
| 65: | pre5V [direct] Supply voltage for preamp input PMOS transistor. |
| 66: | aGND |
| 67: | a5V |
| 68: | aGND |
| 69: | dGND |
| 70: | d5V |
| 71: | testREF [testREF] Reference voltage for tpulse at preamp input |
| | applied to 20fF on chip test cap. |
| 72: | testGND [testGND] Return for testREF voltage. |
| 73: | readamp [readamp] Output from on-chip read amplifier. |
| 74: | rdbias [bias] 356 K to GND, sets readamp bias voltage levels |
| 75: | vns1 [bias] Bias voltage. |
| 76: | vns2 [bias] Bias voltage. |
| 77: | vps1 [bias] Bias voltage. |
| 78: | vps2 [bias] Bias voltage. |
| 79: | scopebias |
| 80: | scopeout |
| 81: | vpb2 [bias] Bias voltage. |
| 82: | vpl3 [bias] Bias voltage. |
| 83: | vpl2 [bias] Bias voltage. |
| 84: | vp2 [bias] Bias voltage. |
| 85: | vp1 [bias] Bias voltage. |
| 86: | vnl1 [bias] Bias voltage. |
| 87: | vn3 |
| 88: | vn2 [bias] Bias voltage. |
| 89: | vn1a [bias] Bias voltage. |
| 90: | vn1 [bias] Bias voltage. |
| 91: | vleak [bias] |
| 92: | discthresh [bias] Sets the threshold voltage for the pixel |
| | discriminator. |
| 93: | discREF [bias] Sets a reference voltage in the shaping amp for the |
| | signal to the pixel discriminator. |
| 94: | a5V |
| 95: | aGND |
| 96: | d5V |
| 97: | dGND |
| 98: | ioVdd [power] supplies 5 V for digital i/o pads |
| 99: | rdreset* [dinput] Complement of rdreset. |
| 100: | power-off [dinput] A chip select signal used when multiple chip |
| | readouts are connected to the same ADC input. |
| 101: | rdreset [dinput] Closes switch in feedback of on-chip readamp for |
| | reset. |
| 102: | cmdclkin [dinput] Clocks in command data on negative-edge. |
| 103: | cdatain [dinput] Command data input. |
| 104: | cdataout [dout] Command data/register output. |
| 105: | tpulse*[dinput] Complement of tpulse. |
| 106: | read [dinput2] Enable signal: when high allows only one colen and |
| | rdcolen to be high, when low all colen are high. |
| 107: | tpulse [dinput] Produces the input test pulse. |
| 108: | lockout* [dinput] Complement of lockout. |
| 109: | lreset* [dinput] Complement of lreset. |
| 110: | lockout [dinput] Prevents setting the ‘trigger’ latch in all pixels. |
| | Asserted a few us after any discriminator firing. |
| 111: | lreset [dinput] Resets all trigger latches. |
| 112: | colsel5 [dinput] Column select bit. |
| 113: | colsel4 [dinput] Column select bit. |
| 114: | colsel3 [dinput] Column select bit. |
| 115: | colsel2 [dinput] Column select bit. |
| 116: | colsel1 [dinput] Column select bit. |
| 117: | colsel0 [dinput] Column select bit. |
| 118: | discout [dout] chip-level discout trigger (in readout mode, discout |
| | signal for selected pixel.) |
| 119: | chenable* [dinput] Complement of chenable. |
| 120: | rstenable* [dinput] Complement of rstenable. |
| 121: | chenable [dinput] Enables the drivers to charge or readout the |
| | sampling capacitors. |
| 122: | rstenable [dinput] Enables the drivers to reset the sampling |
| | capacitors. |
| 123: | ctr-enable* [dinput] Complement of ctr-enable. |
| 124: | ctr-clr* [dinput] Complement of ctr-clr. |
| 125: | ctr-enable [dinput] Enables two on-chip 4-bit counters used to reset |
| | and charge the pixel sampling capacitors. |
| 126: | ctr-clr [dinput] Resets the on-chip 4-bit counters to 0. |
| 127: | clkin* [dinput] Complement of clk. |
| 128: | clkin [dinput] Clock signal for the two 4-bit sampling counters and |
| | capdrivers. |
| 129: | d5V |
| 130: | dGND |
| 131: | aGND |
| 132: | a5V |
| 133: | aGND |
| 134: | pre5V [direct] Supply voltage for preamp input PMOS transistor. |

What is claimed is:

1. A detector system comprising:
a ionizing radiation detector;
a very large-scale integration (VLSI) circuit bonded with the ionizing radiation detector for receiving a signal from the ionizing radiation detector; and
a microprocessor connected with the VSLI circuit for operating the VLSI circuit, wherein signals are received by the ionizing radiation detector, passed through the VLSI circuit, and processed by the microprocessor.

2. A detector system as set forth in claim 1, wherein the ionizing radiation detector is a Cadmium Zinc Telluride (CZT) detector.

3. A detector system as set forth in claim 2, wherein the ionizing radiation detector comprises:
a single CZT crystal having a first side and a second side;
a anode plane connected with the first side of the CZT crystal, wherein the anode plane comprises:
a plurality of pixels; and
a guard ring surrounding the plurality of pixels; and
a cathode connected with the second side of the CZT crystal.

4. A detector system as set forth in claim 3, wherein the VLSI circuit comprises a plurality of readout channels, with each readout channel connected with one of the plurality of pixels, where each readout channel includes:
a pre-amplifier;
a plurality of sampling capacitors;
a shaping amplifier;
a discriminator; and
a latch.

5. A detector as set forth in claim 4, wherein each pre-amplifier is direct current (DC) coupled to the detector.

6. A detector as set forth in claim 5, wherein the plurality of readout channels includes 64 identical readout channels.

7. A detector as set forth in claim 6, where the plurality of sampling capacitors includes 16 sampling capacitors.

8. A detector as set forth in claim 7, wherein the VLSI circuit is formed to support pulse height analysis of X-ray and gamma-ray photons of energies from 20 keV to several MeV.

9. A circuit for measuring charge pulses from a detector, comprising:
a plurality of readout channels, where each readout channel includes:
a pre-amplifier;
a plurality of sampling capacitors;
a shaping amplifier;
a discriminator; and
a latch.
